(19) United States
(12) Patent Application Publication
(10) Pub. No.: US 2020/0033752 A1
(43) Pub. Date: Jan. 30, 2020

(54) POWDER AMOUNT DETECTOR, POWDER SUPPLY DEVICE, AND IMAGE FORMING APPARATUS INCORPORATING SAME

(71) Applicants: Tatsuya Kubo, Kanagawa (JP); Junichi Matsumoto, Kanagawa (JP); Hiroaki Okamoto, Kanagawa (JP); Shuntaroh Tamaki, Kanagawa (JP); Masashi Hommi, Kanagawa (JP); Daisuke Hirano, Kanagawa (JP)

(72) Inventors: Tatsuya Kubo, Kanagawa (JP); Junichi Matsumoto, Kanagawa (JP); Hiroaki Okamoto, Kanagawa (JP); Shuntaroh Tamaki, Kanagawa (JP); Masashi Hommi, Kanagawa (JP); Daisuke Hirano, Kanagawa (JP)

(21) Appl. No.: 16/448,294

(22) Filed: Jun. 21, 2019

(30) Foreign Application Priority Data
Jul. 30, 2018 (JP) 2018-142764

(51) Int. Cl. G03G 15/08

(52) U.S. Cl. CPC G03G 15/0856; G03G 15/0851

(57) ABSTRACT

A powder amount detector is configured to detect an amount of powder in a powder container. The powder amount detector includes a pair of electrodes configured to detect capacitance between the pair of electrodes to detect the amount of powder. The pair of electrodes is flat plate electrodes disposed outside and across the powder container in parallel.

### CROSS-REFERENCE TO RELATED APPLICATION

This patent application is based on and claims priority pursuant to 35 U.S.C. § 119(a) to Japanese Patent Application No. 2018-142764, filed on Jul. 30, 2018, in the Japan Patent Office, the entire disclosure of which is hereby incorporated by reference herein.

### BACKGROUND

### Technical Field

This disclosure generally relates to a powder amount detector, a powder supply device, and an image forming apparatus incorporating the detector and the powder supply device.

### Description of the Related Art

There are powder amount detectors to detect an amount of powder in a powder container. Such a powder amount detector includes, for example, a pair of electrodes that detects the amount of powder based on the capacitance between the pair of electrodes.

### SUMMARY

Embodiments of the present disclosure describe an improved powder amount detector to detect an amount of powder in a powder container. The powder amount detector includes a pair of electrodes configured to detect capacitance between the pair of electrodes to detect the amount of powder. The pair of electrodes is flat plate electrodes disposed outside and across the powder container in parallel.

### BRIEF DESCRIPTION OF THE SEVERAL VIEWS OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic view of a printer as an example of an image forming apparatus according to an embodiment of the present disclosure;

FIG. 2 is a schematic view of one of four image forming units included in the printer in FIG. 1;

FIG. 3 is a schematic view of one of four toner supply devices included in the printer in FIG. 1;

FIG. 4 is a cross-sectional view along a line A-A in FIG. 3;

FIG. 5 is a perspective view of toner containers mounted in a toner container mount of the printer in FIG. 1;

FIG. 6 is a graph illustrating an example of a relation between an amount of toner in the toner container and capacitance;

FIG. 7 is a graph illustrating the relation between an amount of toner in the toner container and capacitance in cases in which a ratio of a length of flat plate electrodes to a length of the toner container is changed;

FIG. 8 is a graph illustrating an example of a calibration curve;

FIG. 9 is a schematic cross-sectional view of the toner container and a pair of electrodes that has an arc shape along an outer circumference of the toner container;

FIGS. 10A and 10B are schematic cross-sectional views of the toner container and the pair of arc-shaped electrodes to illustrate shortcomings of the arc shape;

FIG. 11 is a schematic cross-sectional view of an example of a toner supply device provided with ground electrodes disposed outside parallel flat plate electrodes;

FIG. 12 is a schematic cross-sectional view of an example of a toner supply device provided with ground electrodes between adjacent toner containers;

FIGS. 13A-1, 13A-2, 13B-1, and 13B-2 are schematic cross-sectional views of toner supply devices provided with parallel flat plate electrodes that are vertically disposed across the toner container or horizontally disposed across the toner container; and

FIG. 14 is a schematic view of an example of a toner supply device provided with a plurality of pairs of parallel flat plate electrodes that covers almost an entire toner container.

The accompanying drawings are intended to depict embodiments of the present disclosure and should not be interpreted to limit the scope thereof. The accompanying drawings are not to be considered as drawn to scale unless explicitly noted. In addition, identical or similar reference numerals designate identical or similar components throughout the several views.

### DETAILED DESCRIPTION

In describing embodiments illustrated in the drawings, specific terminology is employed for the sake of clarity. However, the disclosure of this patent specification is not intended to be limited to the specific terminology so selected, and it is to be understood that each specific element includes all technical equivalents that have the same function, operate in a similar manner, and achieve a similar result.

As used herein, the singular forms “a”, “an”, and “the” are intended to include the plural forms as well, unless the context clearly indicates otherwise.

It is to be noted that the suffixes Y, M, C, and K attached to each reference numeral indicate only that components indicated thereby are used for forming yellow, magenta, cyan, and black images, respectively, and hereinafter may be omitted when color discrimination is not necessary.

Descriptions are given of embodiments of the present disclosure with reference to the drawings. It is to be understood that an identical or similar reference character is given to identical or corresponding parts throughout the drawings, and redundant descriptions are omitted or simplified below.

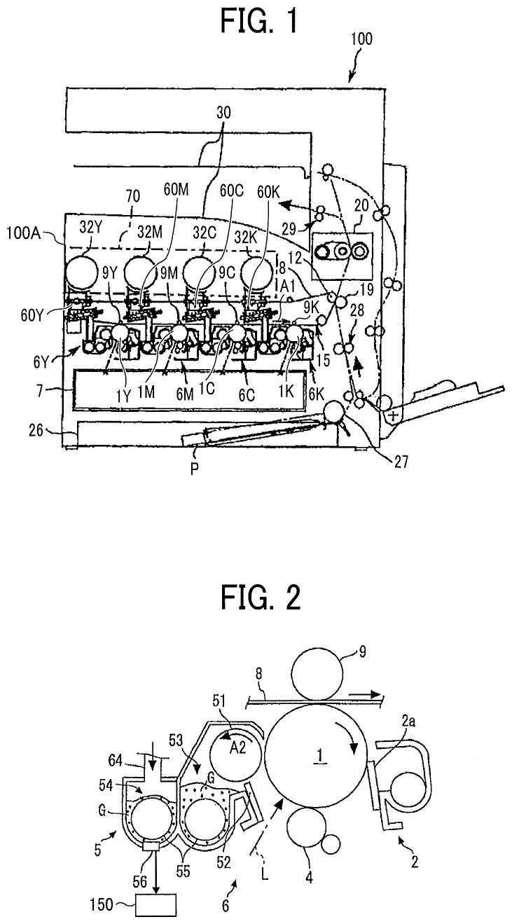

FIG. 1 is a schematic view of a printer 100 as an example of an image forming apparatus according to the embodiments.

The printer 100 includes a toner container mount 70. Four toner containers 32Y, 32M, 32C, and 32K as powder containers (also collectively referred to as “toner containers 32”) to contain yellow, magenta, cyan, and black toners, respectively, are removably installed in the toner container mount 70. That is, the toner containers 32 are replaceable. Below the toner container mount 70, an intermediate transfer unit 15 is disposed. Four image forming units 6Y, 6M, 6C, and 6K (also collectively referred to as “image forming units 6”) are arranged in parallel, facing an intermediate transfer belt 8 of the intermediate transfer unit 15 to form yellow, magenta, cyan, and black (Y, M, C, and K) toner images, respectively. Toner supply devices 60Y, 60M, 60C, and 60K (also collectively referred to as “toner supply devices 60”) are disposed below the toner containers 32Y, 32M, 32C, and 32K, respectively. The toner supply devices 60Y, 60M, 60C, and 60K supply toner contained in the corresponding toner containers 32Y, 32M, 32C, and 32K to the developing devices 5 (see FIG. 2), in which the toner as powder is used, of the corresponding image forming units 6Y, 6M, 6C, and 6K.

The four toner containers 32Y, 32M, 32C, and 32K, the four image forming units 6Y, 6M, 6C, and 6K, and the four toner supply devices 60Y, 60M, 60C, and 60K have similar configurations except the color of toner used therein. Accordingly, in the description below, the suffixes Y, M, C, and K, each representing the color of toner, are omitted unless color discrimination is necessary.

FIG. 2 is a schematic view of one of the four image forming units 6.

Each image forming unit 6 includes a photoconductor 1, and further includes a charging device 4, the developing device 5, a cleaning device 2, a discharger, and the like disposed around the photoconductor 1. Image forming processes, namely charging, exposure, development, transfer, and cleaning processes, are performed on the photoconductor 1, and thus toner images of each color are formed on the photoconductor 1.

The photoconductor 1 rotates clockwise in FIG. 2, driven by a drive motor. At the charging device 4, a surface of the photoconductor 1 is uniformly charged (a charging process). When the surface of the photoconductor 1 reaches a position to receive a laser beam L emitted from an exposure device 7, the photoconductor 1 is scanned with the laser beam L, and thus an electrostatic latent image for each color is formed thereon (an exposure process). Then, the surface of the photoconductor 1 reaches a position opposite the developing device 5, where the electrostatic latent image is developed with toner into the toner image for each color (a development process). At a primary transfer position at which the photoconductor 1 is opposed to a primary transfer roller 9 via the intermediate transfer belt 8, the toner image on the photoconductor 1 is transferred onto the intermediate transfer belt 8 (a primary transfer process). The respective toner images formed on the photoconductors 1Y, 1M, 1C, and 1K (see FIG. 1) are sequentially transferred in layers onto the intermediate transfer belt 8, thereby forming a multicolor toner image on the intermediate transfer belt 8.

After the primary transfer process, a certain amount of untransferred toner remains on the surface of the photoconductor 1. When the surface of the photoconductor 1 reaches a position opposite the cleaning device 2, a cleaning blade 2a of the cleaning device 2 mechanically collects the untransferred toner remaining on the photoconductor 1 (a cleaning process). Subsequently, the surface of the photoconductor 1 reaches a position opposite the discharger, and the discharger removes any residual potential on the photoconductor 1.

The intermediate transfer unit 15 includes the intermediate transfer belt 8, four primary transfer rollers 9Y, 9M, 9C, and 9K, a secondary transfer backup roller 12, multiple tension rollers, and a belt cleaning device. The intermediate transfer belt 8 is stretched and supported by the above-described multiple rollers and is rotated counterclockwise in FIG. 1 as the secondary transfer backup roller 12 of the multiple rollers rotates. The four primary transfer rollers 9Y, 9M, 9C, and 9K press against the corresponding photoconductors 1Y, 1M, 1C, and 1K (also collectively referred to as “photoconductors 1”) via the intermediate transfer belt 8, thereby forming primary transfer nips between the primary transfer rollers 9Y, 9M, 9C, and 9K and the corresponding photoconductors 1Y, 1M, 1C, and 1K.

A transfer bias opposite in polarity to that of the toner is applied to each of the primary transfer rollers 9Y, 9M, 9C, and 9K. The intermediate transfer belt 8 rotates in the direction indicated by arrow A1 in FIG. 1 and sequentially passes through the primary transfer nips of the primary transfer rollers 9Y, 9M, 9C, and 9K. Thus, the single-color toner images on the respective photoconductors 1Y, 1M, 1C, and 1K are primarily transferred and superimposed onto the intermediate transfer belt 8, thereby forming a multicolor toner image.

The intermediate transfer belt 8 carrying the multicolor toner image reaches a position opposite a secondary transfer roller 19. The secondary transfer backup roller 12 and the secondary transfer roller 19 press against each other via the intermediate transfer belt 8, and the contact portion therebetween is hereinafter referred to as a secondary transfer nip. The multicolor toner image on the intermediate transfer belt 8 is transferred onto a recording medium P such as a transfer sheet conveyed to the secondary transfer nip (a secondary transfer process). After the secondary transfer process, a certain amount of untransferred toner, which is not transferred to the recording medium P, remains on the intermediate transfer belt 8. When the intermediate transfer belt 8 reaches a position opposite the belt cleaning device, the untransferred toner is collected from the intermediate transfer belt 8 by the belt cleaning device to complete a series of transfer processes performed on the intermediate transfer belt 8.

The recording medium P is conveyed from a sheet feeding tray 26 disposed in a lower portion of an apparatus body 100A of the printer 100 to the secondary transfer nip via a sheet feeding roller 27 and a registration roller pair 28. More specifically, the sheet feeding tray 26 contains multiple recording media P piled one on another. As the sheet feeding roller 27 rotates counterclockwise in FIG. 1, the sheet feeding roller 27 feeds an uppermost recording medium P in the sheet feeding tray 26 to a roller nip formed between two rollers of the registration roller pair 28. The registration roller pair 28 stops rotating temporarily, stopping the recording medium P with a leading edge of the recording medium P nipped in the registration roller pair 28. The registration roller pair 28 rotates to convey the recording medium P to the secondary transfer nip, timed to coincide with the arrival of the multicolor toner image on the intermediate transfer belt 8. Thus, the multicolor toner image is transferred onto the recording medium P.

The recording medium P onto which the multicolor toner image is transferred at the secondary transfer nip is conveyed to a fixing device 20. In the fixing device 20, a fixing belt and a pressure roller apply heat and pressure to the recording medium P to fix the multicolor toner image on the recording medium P. Subsequently, the recording medium P is ejected by an output roller pair 29 outside the apparatus body 100A. The ejected recording media P are sequentially stacked as output images on a stack tray 30. Thus, a sequence of image forming processes performed in the printer 100 is completed.

Next, a configuration and operation of the developing device 5 of the image forming unit 6 are described in further detail below.

As illustrated in FIG. 2, the developing device 5 includes a developing roller 51 disposed opposite the drum-shaped photoconductor 1, a doctor blade 52 disposed opposite the developing roller 51, and two developer conveying screws 55 respectively disposed in a first developer containing compartment 53 and a second developer containing compartment 54. The developing device 5 further includes a toner concentration sensor 56 to detect a concentration of toner in the developer in the developer containing compartment 54. The developing roller 51 includes stationary magnets, a sleeve that rotates around the magnets, and the like. The developer containing compartments 53 and 54 contain a two-component developer G including carrier and toner. The second developer containing compartment 54 communicates, via an opening on an upper side thereof, with a downward toner passage 64.

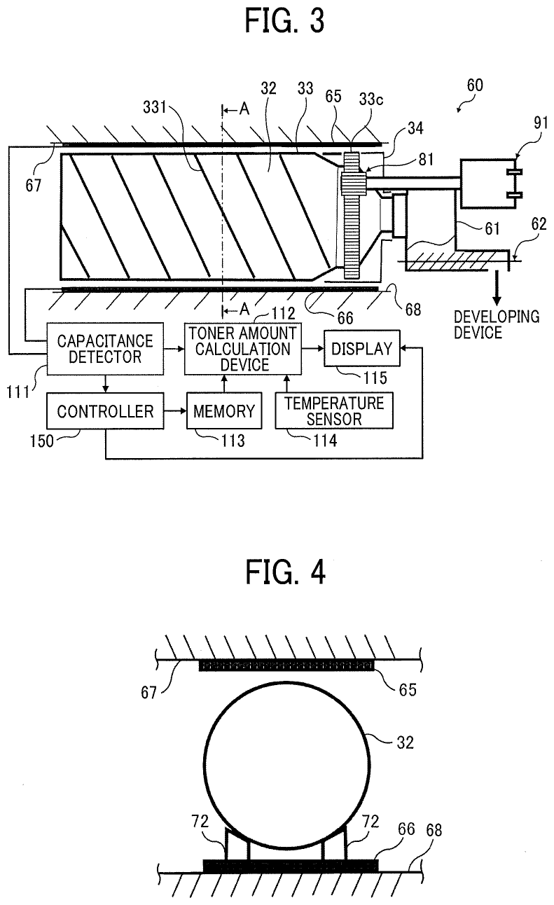

The sleeve of the developing roller 51 rotates counterclockwise as indicated by arrow A2 in FIG. 2. The developer G is carried on the developing roller 51 by a magnetic field generated by the magnets. As the sleeve rotates, the developer G moves along a circumference of the developing roller 51. The percentage (concentration) of toner in the developer G (ratio of toner to carrier) in the developing device 5 is adjusted within a predetermined range. More specifically, the toner supply device 60 (see FIG. 3) supplies toner from the toner container 32 to the developer containing compartment 54 according to the consumption of the toner in the developing device 5. A configuration and operation of the toner supply device 60 are described in detail later.

The developer conveying screws 55 stir the toner supplied to the developer containing compartment 54, together with the developer G, and circulate the toner between the first and second developer containing compartments 53 and 54. The toner in developer G is triboelectrically charged by friction with the carrier and electrostatically attracted to the carrier. Then, the toner is carried on the developing roller 51 together with the carrier by a magnetic force generated on the developing roller 51. The developer G on the developing roller 51 is carried in the direction indicated by arrow A2 in FIG. 2 to a position of the doctor blade 52.

An amount of developer G on the developing roller 51 is adjusted at the position of the doctor blade 52. Then, the developer G is carried to the developing range opposite the photoconductor 1, and toner in the developer G is attracted to the latent image on the photoconductor 1 by an electrical field formed in the developing range. As the sleeve rotates, the developer G remaining on the developing roller 51 reaches an upper portion of the developer containing compartment 53 and separates from the developing roller 51.

Next, the toner supply device 60 and the toner container 32 are described in further detail.

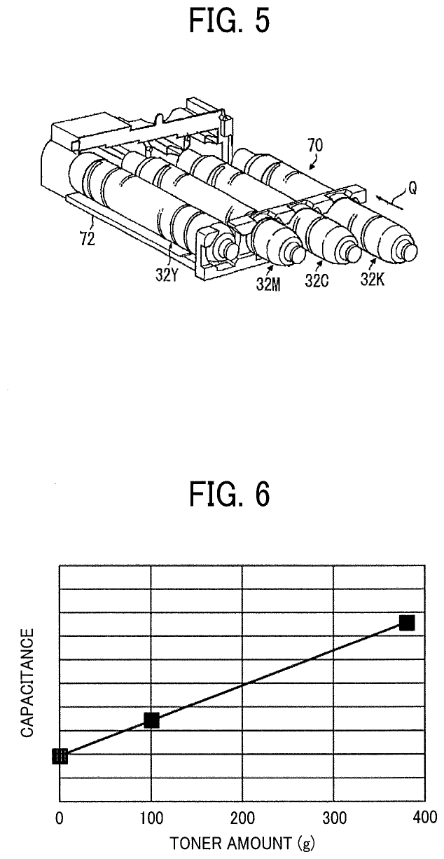

FIG. 3 is a schematic view of one of four toner supply devices 60 included in the printer 100. FIG. 4 is a cross-sectional view along a line A-A in FIG. 3. FIG. 5 is a perspective view of toner containers 32Y, 32M, 32C, and 32K mounted in the toner container mount 70 of the printer 100.

Toners contained in the toner containers 32 for respective colors installed in the toner container mount 70 of the printer 100 are supplied to the corresponding developing devices 5 by the corresponding toner supply devices 60 according to an amount of toner consumption in the developing devices 5.

The toner containers 32 are inserted into the toner container mount 70 of the apparatus body 100A of the printer 100 in the direction indicated by arrow Q in FIG. 5, thereby installing the toner containers 32 in the toner container mount 70.

The toner container 32 is supported by two guides 72 illustrated in FIG. 4. The toner container 32 is approximately cylindrical and mainly includes a cap 34 held by the toner container mount 70 so as not to rotate and a container body 33 formed together with a gear 33c. The container body 33 is held so as to rotate relative to the cap 34, and the gear 33c meshes with an output gear 81 of the toner supply device 60. As a drive motor 91 rotates the output gear 81, driving force is transmitted to the gear 33c of the container body 33, and the container body 33 is rotated while the guides 72 guide an outer circumference of the container body 33.

The container body 33 includes a helical rib 331 protruding inward from an inner circumference face of the container body 33. As the container body 33 rotates, the helical rib 331 conveys the toner in the container body 33 from the container rear end to the container front end (from the left to the right in FIG. 3) in a longitudinal direction of the container body 33. The conveyed toner is discharged from the toner container 32 and supplied to a hopper 61 of the toner supply device 60. That is, the drive motor 91 rotates the container body 33 of the toner container 32 as required, thereby supplying the toner to the hopper 61. The toner container 32Y, 32M, 32C, and 32K are replaced with new ones when the respective service lives thereof have expired, that is, when almost all toner contained in the toner container 32 has been depleted.

As illustrated in FIG. 3, the toner supply device 60 includes the toner container mount 70 (see FIG. 5), the hopper 61, a toner conveying screw 62, and the drive motor 91. The hopper 61 stores the toner supplied from the toner container 32, and the toner conveying screw 62 is disposed in the hopper 61. A controller 150 controls various operations in the printer 100, for example, toner supply, toner concentration adjustment, and the like.

As the controller 150 detects that a toner concentration in the developing device 5 has decreased based on a detection result obtained by the toner concentration sensor 56 (see FIG. 2), the toner conveying screw 62 is rotated in a predetermined period, thereby supplying the toner to the developing device 5. Since the toner conveying screw 62 is rotated to supply toner, the amount of toner supplied to the developing device 5 can be calculated accurately by detecting the number of rotations of the toner conveying screw 62.

The toner end sensor is disposed on a side wall of the hopper 61 and detects that the amount of toner stored in the hopper 61 has fallen below a predetermined amount. For example, a piezoelectric sensor can be used as the toner end sensor. As the toner end sensor detects that the amount of toner stored in the hopper 61 has fallen below a predetermined amount, the drive motor 91 is driven. As a result, the container body 33 of the toner container 32 is rotated in the predetermined period, thereby supplying toner to the hopper 61.

In the present embodiment, the hopper 61 stores toner discharged from the toner container 32, but alternatively, toner discharged from the toner container 32 may be directly supplied to the developing device 5.

In certain image forming apparatuses, an amount of toner remaining in a toner container is estimated and reported to a user. A method to estimate the amount of toner remaining in the toner container is based on cumulative drive duration of a toner conveying screw. Since an amount of toner conveyed by the toner conveying screw is approximately proportional to a rotation angle (a rotation duration), an amount of toner usage can be calculated based on a record of the total rotation duration of the toner conveying screw. Therefore, the amount of toner remaining in the toner container can be calculated by subtracting the amount of toner usage from an initial amount of toner filling the toner container. However, since the amount of toner conveyed by the toner conveying screw varies depending on the environment, driving duration, supply frequency (supply interval), and the like, the estimated value of the amount of toner remaining in the toner container also varies.

Another method to estimate the amount of toner remaining in the toner container is based on an output image pattern. An amount of toner usage to output a printed image can be calculated because an amount of toner adhering to a photoconductor per image area is approximately constant. Therefore, the amount of toner usage can be calculated based on a cumulative image area. However, with this method, it is difficult to accurately estimate the amount of toner remaining in the toner container because the amount of toner adhering to the photoconductor varies due to various errors.

In a comparative example of a toner amount detector, electrodes are disposed on an upper and a lower inner wall surface of a box-shaped toner container, and the amount of toner remaining in the toner container is estimated by measuring capacitance corresponding to an amount of toner. However, the toner may adhere to the electrodes, and the toner is not removed by light force such as vibration and remains on the electrodes because the electrodes are disposed on the inner wall surface of the toner container. If a lot of toner adheres to the electrodes under certain environmental conditions, for example, a false detection of toner still remaining when in fact the toner in the toner container is depleted may occur.

Further, since the electrodes are disposed inside the toner container, the cost of the toner container increases, and the running cost increases. If the toner container is thermally expanded under high temperature environment, a distance between the electrodes varies. As a result, the capacitance corresponding to the amount of toner varies, and the amount of toner remaining in the toner container may not be detected accurately.

Further, to supply electric power to the electrodes of the toner container, which is installable in and removable from the apparatus body, it is required that a connected portion is provided all around an outer circumference surface of the toner container, and a flat spring connection is provided to connect the connected portion of the toner container to the apparatus body, causing extra costs. In addition, as the toner container rotates, the connected portion and the flat spring connection slide each other and are abraded, causing electrical resistance value to vary. If the electrical resistance value varies, the capacitance corresponding to the amount of toner varies, and the amount of toner remaining in the toner container may not be detected accurately.

In the comparative example, a pair of electrodes is disposed near a discharge port of the toner container and an amount of toner near the discharge port is detected by capacitance between the pair of electrodes, thereby estimating an amount of toner remaining in the toner container. However, toner, which is powder and unlike a liquid, is unevenly distributed in the toner container. As a result, with the method in the comparative example to estimate the amount of toner remaining in the toner container by the capacitance near the discharge port, the amount of toner remaining in the toner container may not be accurately detected.

In another comparative example, a pair of electrodes is disposed outside and below the toner container and arranged in parallel with a predetermined space between the pair of electrodes. Capacitance in the toner container is measured by the pair of electrodes, thereby detecting the amount of toner remaining in the toner container. However, a distance between the electrodes and the toner container varies due to a shape error of the toner container or an eccentricity of the toner container during rotation. With this method in which the pair of electrodes is disposed below the toner container and arranged in parallel with the predetermined space between the pair of electrodes and capacitance in the toner container is measured by the pair of electrodes, the capacitance fluctuates due to variation of the distance between the electrodes and the toner container. As a result, it is difficult to accurately detect the amount of toner remaining in the toner container.

In the present embodiment, as illustrated in FIGS. 3 and 4, a pair of flat plate electrodes 65 and 66 sandwiches the toner container 32 in parallel and covers almost the entire toner container 32. Specifically, a width of the flat plate electrodes 65 and 66 in a transverse direction (the left and right direction in FIG. 4) is longer than a diameter of the toner container 32, and a length of the flat plate electrodes 65 and 66 in a longitudinal direction of the toner container 32 (the left and right direction in FIG. 3) is longer than or equal to a half length of the toner container 32.

The flat plate electrode 65 is secured to an upper wall surface 67 of the apparatus body 100A, which is opposed to an upper side of the toner container 32, by double-sided adhesive tape, and the flat plate electrode 66 is secured to a lower wall surface 68 of the apparatus body 100A, which is opposed to a lower side of the toner container 32, by double-sided adhesive tape. The flat plate electrodes 65 and 66 in parallel are made of any conductive material, for example, iron plate in the present embodiment.

A pair of flat plate electrodes 65 and 66 in parallel has the same size, thereby preventing a density of lines of electric force between the flat plate electrodes 65 and 66 from varying. Accordingly, uneven distribution of toner in the toner container 32 does not cause the capacitance to vary relative to the same amount of toner.

Each of the flat plate electrodes 65 and 66 is connected to the capacitance detector 111. The capacitance detector 111 applies electric power to the pair of flat plate electrodes 65 and 66 in parallel, thereby detecting the capacitance between the pair of flat plate electrodes 65 and 66 in parallel.

A known method of detecting capacitance can be used. In the present embodiment, a charging method is used in which the capacitance is measured by a relation between the time of charge arrival point and the voltage or current while a constant voltage or a constant current is applied between the pair of flat plate electrodes 65 and 66.

The detection result obtained by the capacitance detector 111 is transmitted to a toner amount calculation device 112, and a toner amount calculation device 112 calculates the amount of toner remaining in the toner container 32 based on the measured capacitance. The measured capacitance varies depending on a dielectric constant between the flat plate electrodes 65 and 66. Toner has a higher dielectric constant than air. Therefore, the dielectric constant varies according to the amount of toner in the electric field between the flat plate electrodes 65 and 66 in parallel. As a result, the capacitance varies according to the amount of toner in the toner container 32 sandwiched by the pair of flat plate electrodes 65 and 66. Thus, the amount of toner in the toner container 32 can be calculated by detecting the capacitance.

In the present embodiment, the toner amount calculation device 112 calculates the amount of toner remaining in the toner container 32 based on the calibration curve stored in a memory 113 and the capacitance obtained by the capacitance detector 111. The calibration curve preliminarily acquired indicates the relation between the capacitance and the amount of toner in the toner container 32. A temperature sensor 114 is provided to detect temperature around the toner container 32, and the amount of toner remaining (i.e., the amount of toner remaining in the toner container 32) is corrected based on a detection result obtained by the temperature sensor 114. The amount of toner remaining obtained by the toner amount calculation device 112 is displayed on a display 115 (e.g., a control panel).

As described above, in the present embodiment, a powder amount detector (a toner amount detector) includes the flat plate electrodes 65 and 66 in parallel, the capacitance detector 111, the toner amount calculation device 112, the memory 113, the temperature sensor 114, and the display 115.

In the present embodiment, the flat plate electrodes 65 and 66 are disposed outside the toner container 32 in parallel, thereby preventing toner from adhering to the flat plate electrodes 65 and 66. Therefore, the amount of toner remaining can be detected accurately. The number of components and the cost of the toner container 32 can be reduced. Under high temperature environment, the amount of toner remaining can be accurately detected without being affected by thermal expansion of the toner container 32.

With such a configuration in which the pair of flat plate electrodes 65 and 66 sandwich the toner container 32 in parallel, the capacitance does not vary due to the shape error or rotational eccentricity of the toner container 32. Therefore, the amount of toner remaining can be detected accurately.

In the present embodiment, a pair of flat plate electrodes 65 and 66 covers almost the entire toner container 32. With this configuration, since almost all toner in the toner container 32 is included in the lines of electric force between the pair of flat plate electrodes 65 and 66 (i.e., electric field), the amount of toner remaining in the toner container 32 can be detected accurately, and the accurate amount of toner remaining can be reported to a user.

FIG. 6 is a graph illustrating an example of a relation between the amount of toner in the toner container 32 and the capacitance.

As illustrated in FIG. 6, the relation between the amount of toner in the toner container 32 and the capacitance is approximately liner. Therefore, the amount of toner remaining in the toner container 32 can be accurately calculated based on the capacitance.

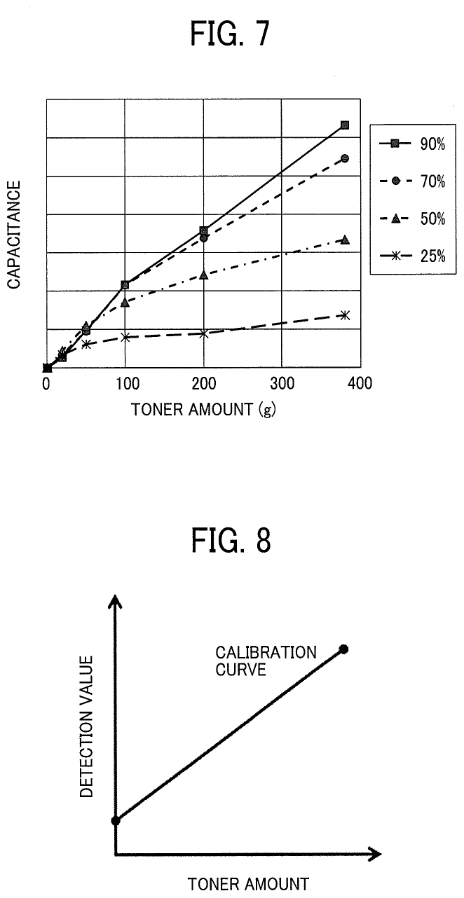

FIG. 7 is a graph illustrating a relation between the amount of toner in the toner container 32 and the capacitance in cases in which a ratio of the length of the flat plate electrodes 65 and 66 to the length of the toner container 32 is changed.

As illustrated in FIG. 7, the ratio of the length of the flat plate electrodes 65 and 66 to the length of the toner container 32 becomes higher, sensitivity of detecting the capacitance becomes higher when the amount of toner remaining in the toner container 32 is large, that is, the capacitance variation relative to changes of the amount of toner are great. As illustrated in FIG. 7, the sensitivity of the ratio of 25% is low when the amount of toner remaining in the toner container 32 is large. Therefore, the amount of toner remaining may not be accurately calculated. Accordingly, as illustrated in FIG. 7, the ratio of the length of the flat plate electrodes 65 and 66 to the length of the toner container 32 is preferably 50% or more, more preferably 70% or more. Thus, when the ratio of the length of the flat plate electrodes 65 and 66 to the length of the toner container 32 is 50% or more, the amount of toner remaining in the toner container 32 can be accurately detected from when the amount of toner remaining is large to when amount of toner remaining is small.

A distance between the flat plate electrodes 65 and 66 may be different for each device due to an assembly error. Therefore, in the present embodiment, the powder amount detector employs a calibration curve calculation to acquire a calibration curve as illustrated in FIG. 8. Before factory shipment, the calibration curve calculation is performed, and the calibration curve is acquired and stored in the memory 113. The calibration curve calculation can be performed by a certain operation on the control panel of the printer 100 as the image forming apparatus.

As the calibration curve calculation starts, the controller 150 causes the control panel to display an instruction to install an empty toner container 32 in the toner container mount 70. After setting the empty toner container 32 in the toner container mount 70, an operator operates the control panel, for example, pushes a start button, thereby measuring capacitance. After measuring the capacitance of the empty toner container 32, the controller 150 causes the control panel to display an instruction to install a full toner container 32 in the toner container mount 70. After setting the full toner container 32 in the toner container mount 70, the operator operates the control panel, thereby measuring capacitance. After measuring the capacitance of the full toner container 32, the controller 150 acquires a calibration curve based on the capacitances of the empty and full toner containers 32 and stores the calibration curve in the memory 113. The calibration curve calculation is performed for each color of Y, M, C, and K. Alternatively, the controller 150 may acquire a calibration curve based on capacitance without the toner container 32 and the capacitance of the full toner container 32.

In the present embodiment, the temperature sensor 114 is provided to detect temperature around the toner container 32, and the amount of toner is corrected based on a detection result obtained by the temperature sensor 114. This is because the distance between flat plate electrodes 65 and 66 varies due to the thermal expansion of components to which the flat plate electrodes 65 and 66 are secured (i.e., components constituting the upper wall surface 67 or the lower wall surface 68). As a result, the capacitance between the flat plate electrodes 65 and 66 varies. As an example, a correction factor α at high temperature and a correction factor β at low temperature are stored in the memory 113. If a temperature detected by the temperature sensor 114 is equal to or higher than a predetermined first threshold, the amount of toner remaining is corrected by multiplying the calculated amount of toner remaining by the correction factor α at high temperature. If the temperature detected by the temperature sensor 114 is equal to or lower than a second threshold which is lower than the first threshold, the amount of toner remaining is corrected by multiplying the calculated amount of toner remaining by the correction factor β at low temperature. As a result, the calculation error of the amount of toner remaining due to an ambient temperature is minimized, thereby acquiring the amount of toner remaining accurately.

As described above, the calculated amount of toner remaining is corrected according to temperature, but alternatively, the detected capacitance can be corrected according to temperature.

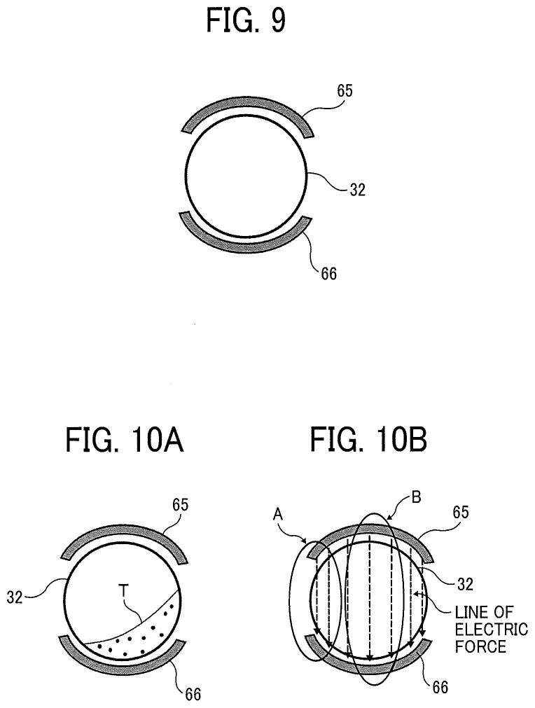

In the present embodiment, the pair of electrodes is flat plates in parallel. The powder amount detector with the flat plates in parallel can accurately detect the amount of toner remaining as compared with an example in FIG. 9 in which a pair of electrodes has arc shape along an outer circumference of the toner container 32.

FIGS. 10A and 10B are schematic cross-sectional views of the toner supply device 60 illustrating a drawback of the pair of arc-shaped electrodes.

Toner T in the toner container 32 forms various shapes in a cross-section perpendicular to a rotation axis direction of the toner container 32, for example, the toner T is unevenly distributed as illustrated in FIG. 10A, or the toner T is evenly distributed. In a case of the pair of electrodes 65 and 66 having the arc shape, as illustrated in FIG. 10B, a distance between ends of the pair of electrodes 65 and 66 is shorter than a distance between center portions of the pair of electrodes 65 and 66. As a result, a density of lines of electric force in area A near the ends of the pair of electrodes 65 and 66 is higher than a density of lines of electric force in area B near the center portions of the pair of electrodes 65 and 66. Accordingly, even if a toner height is even in the left and right direction in FIG. 10B, capacitance is different between area A in which the density of lines of electric force is high and area B in which the density of lines of electric force is low. As a result, even if the amount of toner in the toner container 32 is same, the capacitance when the toner T is unevenly distributed is different from the capacitance when the toner T is evenly distributed. Therefore, the amount of toner may not be accurately detected.

On the contrary, in the present embodiment, since the pair of flat plate electrodes 65 and 66 is flat plates in parallel, the lines of electric force between the pair of flat plate electrodes 65 and 66 are uniform. The capacitance when the toner T is unevenly distributed is not different from the capacitance when the toner T is evenly distributed. Therefore, the amount of toner can be accurately detected.

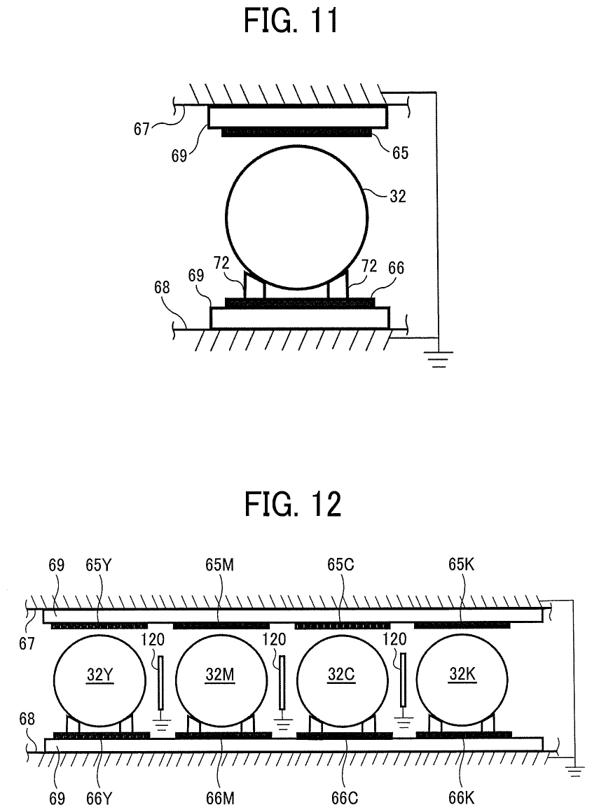

FIG. 11 is a schematic cross-sectional view of an example of a toner supply device 60 provided with ground electrodes disposed outside the flat plate electrodes 65 and 66 in parallel.

As illustrated in FIG. 11, the flat plate electrodes 65 and 66 are attached to the upper and lower wall surfaces 67 and 68 via insulators 69. Components constituting the upper and lower wall surface 67 and 68 is grounded, thereby functioning as ground electrodes.

As illustrated in FIGS. 1 and 2, the photoconductors 1, the charging devices 4, the intermediate transfer unit 15, and the like are disposed below the toner containers 32. This configuration may cause capacitance to vary. In the present embodiment, since the component constituting the lower wall surface 68 is grounded as the ground electrode, electrical noise from the photoconductors 1, the charging devices 4, the intermediate transfer unit 15 can be cut off.

Above the toner containers 32 the printed recording media P are stacked, the control panel is disposed, and an operator may put the hand on the stack tray 30. This configuration may cause capacitance to vary. In the present embodiment, since the component constituting the upper wall surface 67 is grounded as the ground electrode, electrical noises from above can be cut off.

Therefore, the capacitance variation due to the electrical noises can be minimized, and the amount of toner can be accurately detected.

Note that the ground electrodes (i.e., the upper and lower wall surfaces 67 and 68) are preferably larger than the flat plate electrodes 65 and 66, and cover the flat plate electrodes 65 and 66 as viewed from the ground electrodes (i.e., the upper and lower wall surfaces 67 and 68).

FIG. 12 is a schematic cross-sectional view of an example of a toner supply device 60 provided with ground electrodes 120 that are partitioned between adjacent toner containers 32.

Without the ground electrodes 120 described above, a part of lines of electric force between the flat plate electrodes 65 and 66 (i.e., the lines of electric force near the adjacent toner container 32) may be changed due to the toner in the adjacent toner container 32. That is, current flows through the toner in the adjacent toner container 32. As a result, the capacitance may vary according to the amount of toner in the adjacent toner container 32, and the amount of toner may not be accurately detected.

However, as illustrated in FIG. 12, since the ground electrodes 120 are partitioned between the adjacent toner containers 32, the lines of electric force between the flat plate electrodes 65 and 66 are cut off by the ground electrodes 120. That is, a part of the lines of electric force between the flat plate electrodes 65 and 66 is directed toward the ground electrode 120 but does not go the adjacent toner container 32 beyond the ground electrode 120. Therefore, this configuration can prevent the capacitance to be detected from being affected by the amount of toner in the adjacent toner container 32, and the amount of toner can be accurately detected.

The ground electrodes 120 may be disposed on the left and right side in FIG. 12 in a direction perpendicular to the surface of the paper on which FIG. 12 is drawn so as to surround the four toner containers 32Y, 32M, 32C, and 32K. Therefore, the ground electrodes 120 can cut off electrical noises caused by human passing by or another device disposed on the side, front, or back of the printer 100, and the amount of toner can be more accurately detected.

Alternatively, the flat plate electrodes 65 and 66 in parallel may be disposed across the toner container 32 in the lateral direction, which is perpendicular to the rotation axis direction of the toner container 32 and the vertical direction. However, the parallel flat plate electrodes 65 and 66 (i.e., the flat plate electrodes 65 and 66 in parallel) are preferably disposed across the toner container 32 in the vertical direction.

FIGS. 13A-1, 13A-2, 13B-1, and 13B-2 are schematic cross-sectional views of the toner supply devices 60 provided with the parallel flat plate electrodes 65 and 66 that are vertically disposed across the toner container 32 and laterally disposed across the toner container 32, respectively. GND indicated by broken lines in FIGS. 13A-1, 13A-2, 13B-1, and 13B-2 represent ground electrodes.

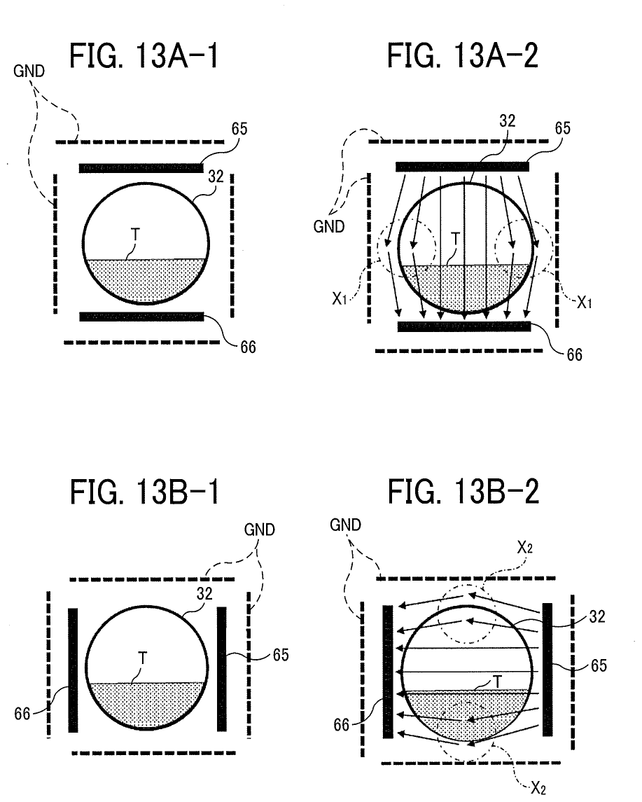

As illustrated in FIGS. 13A-2 and 13B-2, the lines of electric force are directed to the ground electrode (GND) near the ends of the parallel flat plate electrodes 65 and 66 (i.e., the flat plate electrodes 65 and 66 in parallel) under the influence of the ground electrode. As a result, in areas X₁ and X₂ indicated by dash-dotted circles in FIGS. 13A-2 and 13B-2, the density of lines of electric force is low as compared with the other areas. Accordingly, sensitivity of detecting capacitance is lowered.

When the parallel flat plate electrodes 65 and 66 are disposed across the toner container 32 in the vertical direction, the sensitivity is lowered in the area X₁ indicated by the dash-dotted circles in FIG. 13A-2, located near the middle of the toner container 32 in the vertical direction. On the other hand, when the parallel flat plate electrodes 65 and 66 are disposed across the toner container 32 in the lateral direction, the sensitivity is lowered in the area X₂ indicated by the dash-dotted circles in FIG. 13B-2, located near the top portion and bottom portion of the toner container 32. Therefore, in the case in which the parallel flat plate electrodes 65 and 66 are disposed across the toner container 32 in the lateral direction, the sensitivity is lowered when the amount of toner remaining in the toner container 32 is small.

When the powder amount detector detects that the amount of toner remaining in the toner container 32 is small based on the capacitance, the printer 100 notifies a user that the toner is nearly depleted and prompts the user to prepare a replacement toner container 32. As the powder amount detector detects that the toner in the toner container 32 is depleted based on the capacitance, the printer 100 notifies a user of toner depletion and prompts the user to replace of the toner container 32. Accordingly, in the case in which the parallel flat plate electrodes 65 and 66 are disposed across the toner container 32 in the lateral direction, the detection of the near or complete depletion of the toner may not be accurately detected because of the low sensitivity when the amount of toner remaining in the toner container 32 is small.

Therefore, a vertical arrangement in which the parallel flat plate electrodes 65 and 66 are disposed across the toner container 32 in the vertical direction is more preferable than a lateral arrangement in which the parallel flat plate electrodes 65 and 66 are disposed across the toner container 32 in the lateral direction, which is perpendicular to the rotation axis direction of the toner container 32 and the vertical direction. This is because the toner near depletion and the toner depletion can be detected with high accuracy.

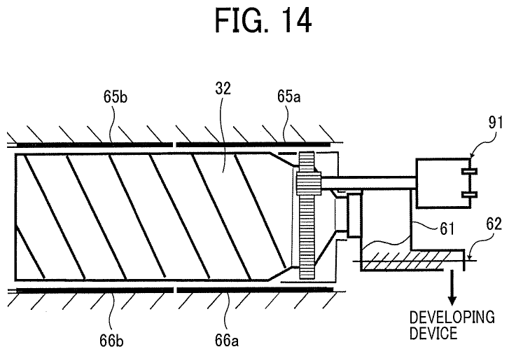

FIG. 14 is a schematic view of an example of a toner supply device 60 provided with a plurality of pairs of parallel flat plate electrodes 65a, 65b, 66a, and 66b that covers almost an entire toner container 32.

With this configuration, total capacitance of entire toner container 32 can be acquired by adding together capacitance between parallel flat plate electrodes 65a and 66a on the downstream side of the toner container 32 in a direction to discharge toner (i.e., the right side in FIG. 14) and capacitance between parallel flat plate electrodes 65b and 66b on the upstream side of the toner container 32 in the direction to discharge toner (i.e., the left side in FIG. 14). Thus, similarly to the case in which the pair of parallel flat plate electrodes 65 and 66 covers almost the entire toner container 32, the amount of toner remaining in the toner container 32 can be accurately acquired.

Further, as illustrated in FIG. 14, a pair of parallel flat plate electrodes is divides into a plurality of pairs of electrodes (e.g., the pair of parallel flat plate electrodes 65a and 66a, and the pair of parallel flat plate electrodes 65b and 66b) in the longitudinal direction of the toner container 32, causing the following advantage. Since toner in the toner container 32 is conveyed to a discharge side of the toner container 32 by the helical rib 331, the amount of toner on the downstream side of the toner container 32 in the direction to discharge toner is approximately constant until the amount of toner in the toner container 32 decreases to some extent. Therefore, the capacitance between the parallel flat plate electrodes 65a and 66a on the downstream side of the toner container 32 in the direction to discharge toner is approximately constant until the amount of toner in the toner container 32 decreases to some extent.

On the other hand, the amount of toner on the upstream side of the toner container 32 in the direction to discharge toner decreases from the beginning of use because toner on the upstream side of the toner container 32 is conveyed toward the discharge side of the toner container 32. Accordingly, the capacitance between the parallel flat plate electrodes 65b and 66b on the upstream side of the toner container 32 in the direction to discharge toner greatly varies from the beginning of use (i.e., the sensitivity of detecting capacitance is high at the beginning of use). Therefore, the abnormalities that toner is abnormally discharged from the toner container 32 or toner clogs a passage from the toner container 32 to the developing device 5 or the hopper 61 can be discovered early by the capacitance variation between the parallel flat plate electrodes 65b and 66b on the upstream side of the toner container 32 in the direction to discharge toner. Thus, since abnormality can be discovered early, there are advantages that it may not take time to replace the component or repair.

According to the present disclosure, the amount of powder remaining in the powder container can be accurately detected. The embodiments described above are examples, the following aspects of the present disclosure can attain, for example, the following effects, respectively.

### Aspect 1

A powder amount detector includes a pair of electrodes configured to detect an amount of powder such as an amount of toner in a powder container such as the toner container 32 based on capacitance between the pair of electrodes. The pair of electrodes is flat plate electrodes such as the flat plate electrodes 65 and 66 disposed outside and across the powder container in parallel. In the above-described embodiment, the powder amount detector includes parallel flat plate electrodes 65 and 66, a capacitance detector 111, a toner amount calculation device 112, and the like.

The powder container may be thermally expanded under high temperature environment. In the above-described powder amount detector in the comparative example, since the flat plate electrodes are disposed on the inner wall surface of the powder container, if the toner container thermally expands, the distance between the flat plate electrodes is changed, thereby varying capacitance relative to the amount of powder. As a result, the amount of powder remaining in the powder container may not be detected accurately.

In Aspect 1, since the flat plate electrodes are disposed outside the powder container, a distance between the parallel flat plate electrodes does not change even if the powder container thermally expands. According to Aspect 1, the powder amount detector can accurately detect the amount of powder under high temperature environment.

### Aspect 2

In the powder amount detector according to Aspect 1, the flat plate electrodes have a same size.

As described in the above embodiments, the powder amount detector can prevent a density of lines of electric force between the flat plate electrodes from varying. Accordingly, uneven distribution of powder in the powder container such as the toner container 32 does not cause the capacitance to vary relative to the same amount of powder.

### Aspect 3

In the powder amount detector according to Aspect 1 or 2, ground electrodes such as the ground electrodes (i.e., the upper and lower wall surface 67 and 68) are disposed outside the flat plate electrodes and grounded electrically.

According to Aspect 3, as described in the above-described embodiments, the ground electrodes can cut off electrical noises outside the flat plate electrodes. Accordingly, the amount of powder remaining in the powder container such as the toner container 32 can be accurately detected.

### Aspect 4

In the powder amount detector according to Aspect 3, a size of the ground electrodes is greater than or equal to a size of the flat plate electrodes.

According to Aspect 3, as described in the above-described embodiments, the ground electrodes can satisfactorily cut off electrical noises outside the flat plate electrodes.

### Aspect 5

In the powder amount detector according to any one of Aspects 1 through 4, a length of the flat plate electrodes is greater than or equal to a half length of the powder container such as the toner container 32 in a longitudinal direction of the powder container.

Accordingly, as described in the above embodiment, the powder remaining amount in the powder container such as the toner container 32 can be accurately detected from when the powder remaining amount (e.g., the amount of toner remaining) is large to when powder remaining amount is small.

### Aspect 6

The powder amount detector according to any one of Aspects 1 through 4, further includes another pair of electrodes, which is flat plate electrodes, disposed outside and across the powder container such as the toner container 32 in parallel. The another pair of electrodes and the pair of electrodes are arranged side by side in a longitudinal direction of the powder container.

According to Aspect 6, as described with reference to FIG. 14, the abnormalities of supplying powder that powder is abnormally discharged from the powder container such as the toner container 32 can be discovered early based on capacitance variation between the flat plate electrodes on the upstream side of the powder container in a direction to discharge powder.

### Aspect 7

The powder amount detector according to any one of Aspects 1 through 6 further includes a memory such as the memory 113 configured to store a calibration curve indicating a relation between the capacitance between the pair of electrodes and the amount of powder in the powder container such as the toner container 32. The powder amount detector is configured to detect the amount of powder based on the calibration curve and the capacitance between the pair of electrodes. The powder amount detector is configured to measure the capacitance between the pair of electrodes when the powder container is empty and the capacitance between the pair of electrodes when the powder container is full to acquire the calibration curve (i.e., the calibration curve calculation).

Accordingly, as described in the above embodiment, a capacitance error due to an assembly error can be eliminated, and the amount of powder remaining in the powder container such as the toner container 32 can be accurately detected.

### Aspect 8

The powder amount detector according to any one of Aspects 1 through 7 further includes a memory such as the memory 113 configured to store a calibration curve indicating a relation between the capacitance and the amount of powder in the powder container such as the toner container 32 and a temperature detector such as the temperature sensor 114 configured to detect temperature. The powder amount detector is configured to detect the amount of powder based on the calibration curve, the measured capacitance between the pair of electrodes, and the temperature detected by the temperature detector.

According to Aspect 8, as described in the above-described embodiments, the amount of powder in the powder container can be acquired in consideration of the influence of temperature, such as capacitance variation due to thermal expansion and contraction of the component to which the electrode is secured. Accordingly, the amount of powder in the powder container can be accurately detected as compared with the case in which the powder amount detector detects the amount of powder based on the calibration curve and the measured capacitance between the pair of electrodes.

### Aspect 9

A powder supply device such as the toner supply device 60 includes the powder container such as the toner container 32 and the powder amount detector according to any one of Aspects 1 through 8, to supply powder in the powder container.

Accordingly, the amount of powder in the powder container can be accurately detected.

### Aspect 10

In the powder supply device according to Aspect 9, the powder container is cylindrical and configured to rotate.

Accordingly, as described in the above embodiment, the powder container may be eccentric. However, as described in Aspect 1, the pair of flat plate electrodes is disposed outside and across the powder container in parallel. Accordingly, if the powder container is eccentric, the capacitance between the flat plate electrodes does not vary, and the amount of powder in the powder container can be accurately detected.

### Aspect 11

The powder supply device according to Aspect 9 or 10 further includes a plurality of powder containers, including the powder container, arranged in parallel, a plurality of powder amount detectors, including the powder amount detector, provided corresponding to the plurality of powder containers, respectively, and a plurality of ground electrodes disposed between the plurality of powder containers and electrically grounded.

According to Aspect 11, as described in the above embodiment, the ground electrodes such as the ground electrodes 120 can cut off the influence of the powder in the adjacent powder container, thereby detecting the amount of powder in the powder container accurately.

### Aspect 12

An image forming apparatus such as the printer 100 includes an image bearer such as the photoconductor 1 configured to bear a latent image, a developing device such as the developing device 5 configured to develop the latent image on the image bearer with a developer, a developer container such as the toner container 32 configured to contain the developer used in the developing device, the powder supply device such as the toner supply device 60 according to any one of Aspects 9 through 11 configured to supply the developer in the developer container to the developing device.

According to Aspect 12, the amount of developer in the developer container such as the toner container 32 can be accurately detected.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

What is claimed is:

1. A powder amount detector to detect an amount of powder in a powder container, the powder amount detector comprising:
a pair of electrodes configured to detect capacitance between the pair of electrodes to detect the amount of powder, the pair of electrodes being flat plate electrodes disposed outside and across the powder container in parallel.

2. The powder amount detector according to claim 1,
wherein the flat plate electrodes have a same size.

3. The powder amount detector according to claim 1, further comprising ground electrodes disposed outside the flat plate electrodes and grounded electrically.

4. The powder amount detector according to claim 3,
wherein a size of the ground electrodes is greater than or equal to a size of the flat plate electrodes.

5. The powder amount detector according to claim 1,
wherein a length of the flat plate electrodes is greater than or equal to a half length of the powder container in a longitudinal direction of the powder container.

6. The powder amount detector according to claim 1, further comprising another pair of electrodes being flat plate electrodes disposed outside and across the powder container in parallel,
wherein said another pair of electrodes and the pair of electrodes are arranged side by side in a longitudinal direction of the powder container.

7. The powder amount detector according to claim 1, further comprising a memory configured to store a calibration curve indicating a relation between the capacitance between the pair of electrodes and the amount of powder in the powder container,
wherein the powder amount detector is configured to detect the amount of powder based on the calibration curve and the capacitance between the pair of electrodes, and
wherein the powder amount detector is configured to measure the capacitance between the pair of electrodes when the powder container is empty and the capacitance between the pair of electrodes when the powder container is full to acquire the calibration curve.

8. The powder amount detector according to claim 1, further comprising:
a memory configured to store a calibration curve indicating a relation between the capacitance and the amount of powder in the powder container; and
a temperature detector configured to detect temperature,
wherein the powder amount detector is configured to detect the amount of powder based on the temperature detected by the temperature detector and a detection result obtained by the powder amount detector.

9. A powder supply device comprising:
the powder amount detector according to claim 1; and
the powder container.

10. The powder supply device according to claim 9,
wherein the powder container is cylindrical and configured to rotate.

11. The powder supply device according to claim 9, further comprising a plurality of powder containers, including the powder container, arranged in parallel;
a plurality of powder amount detectors, including the powder amount detector, provided corresponding to the plurality of powder containers, respectively; and
a plurality of ground electrodes disposed between the plurality of powder containers and electrically grounded.

12. An image forming apparatus comprising:
an image bearer configured to bear a latent image;
a developing device configured to develop the latent image on the image bearer with a developer;
a developer container configured to contain the developer; and
the powder supply device according to claim 9 configured to supply the developer in the developer container to the developing device.
